(19) United States
(12) Patent Application Publication
(10) Pub. No.: US 2025/0311887 A1
(43) Pub. Date: Oct. 9, 2025

(54) BATTERY POWERED BLENDER

(71) Applicant: Sunbeam Products, Inc., Atlanta, GA (US)

(72) Inventors: Steve Vernaglia, Delray Beach, FL (US); Eugene Goldenberg, Boca Raton, FL (US)

(21) Appl. No.: 18/865,423

(22) PCT Filed: Jun. 1, 2023
(86) PCT No.: PCT/US2023/067761

§ 371 Date: Nov. 13, 2024

Related U.S. Application Data
(60) Provisional application No. 63/365,649, filed on Jun. 1, 2022.

(51) Int. Cl. A47J 43/046; A47J 43/08

(52) U.S. Cl. CPC A47J 43/046; A47J 43/08

(57) ABSTRACT

The present disclosure generally relates to a portable battery-operated blender, and more particularly, to a blender base for a portable battery-operated blender. The blender base comprises a motor having a motor shaft rotatably coupled thereto. The motor shaft is in turn operably coupled to a blade assembly. The longitudinal axis of the motor shaft is generally angled with respect to the longitudinal axis of the blender base. In some instances, a load sensing controller is operatively coupled to the motor, the load sensing controller configured to change the motor direction and/or speed when a load imbalance is detected in the blender base.

### CROSS-REFERENCE TO RELATED APPLICATIONS

The present application claims the benefit of U.S. Provisional Patent Application Ser. No. 63/365,649, filed Jun. 1, 2022, the entire contents of which are herein incorporated by reference.

### FIELD OF THE INVENTION

The present disclosure generally relates to battery-powered blender having an efficient motor and blade assembly.

### BACKGROUND OF THE INVENTION

Portable versions of blender systems are becoming more prevalent due to the convenience of being able to create blended concoctions in any location. Portable blenders are typically battery powered, and users are therefore not limited to external power source locations. However, such battery-powered systems may be unreliable and produce inconsistent results due to the decreased power specifications compared to standard AC-powered blenders. Accordingly, battery-powered systems currently on the market may not have sufficient power to blend various ingredients or mixtures to a desired consistency or smoothness. As a result, prepared foodstuffs may include portions of unblended ingredients or have an otherwise non-homogenous consistency.

Further, due to the aforementioned battery power limitations, portable blenders can easily jam during the blending process. Ingredients, and in particular, ice or other frozen ingredients, can become lodged around or underneath the blender blades within the blender vessel. Users must then manually dislodge the unprocessed ingredients before proceeding, which can be time consuming and may result in injury due to the sharpness of the blades.

Accordingly, there is a need in the art for a battery-powered blender having improved efficiency to create homogenously blended products while preventing capture of unprocessed ingredients around or in the blade area.

### BRIEF SUMMARY OF THE INVENTION

The present disclosure is generally directed to a blender base operated on battery power and intended to provide improved efficiency in blending action. The blender base can be used in combination with a blender container mated thereto to create any variety of blended, crushed, or chopped concoctions.

The blender base generally includes a blade assembly comprising at least one blade, which is operably coupled to a motor. A motor shaft is rotatably coupled to the motor and links the blade assembly and the motor. When powered on, the motor causes rotation of the motor shaft, which thereby imparts rotation to the blade assembly, causing blending of any ingredients contained within any connected blender container.

In some embodiments, the longitudinal axis of the motor shaft can be angled with respect to the longitudinal axis of the blender base. For example, the longitudinal axis of the motor shaft is angled from about 5 degrees to about 25 degrees with respect to the longitudinal axis of the blender base. The angle of the motor shaft may cause the blade assembly to also be angled. During ingredient processing, the angle of the blade assembly preferably creates an elliptical flow of blended foodstuffs. The elliptical flow imparts upwards and downwards agitation of any ingredients contained within the blender, which aids in blending efficiency (e.g., timeliness, convenience, and homogeneity of the blended concoction).

In some embodiments, the blender base motor can be operatively coupled to a controller, for example, a load sensing controller. The load sensing controller is configured to detect any load imbalance in the blender container (i.e., on the blender base). Once an imbalance is detected, the controller causes a change in speed or direction of the motor, thereby causing a change in speed or direction of the rotation of the blade assembly. The change in speed or direction is intended to dislodge any unprocessed ingredients jammed underneath or in the blade assembly.

### BRIEF DESCRIPTION OF THE SEVERAL VIEWS OF THE DRAWINGS

FIG. 1 is a perspective view of a blender base for a portable blender assembly.

FIG. 2 is a longitudinal cross-sectional view of the blender base taken through line 2-2 of FIG. 1.

Corresponding reference characters indicate corresponding parts throughout the drawings.

### DETAILED DESCRIPTION OF THE INVENTION

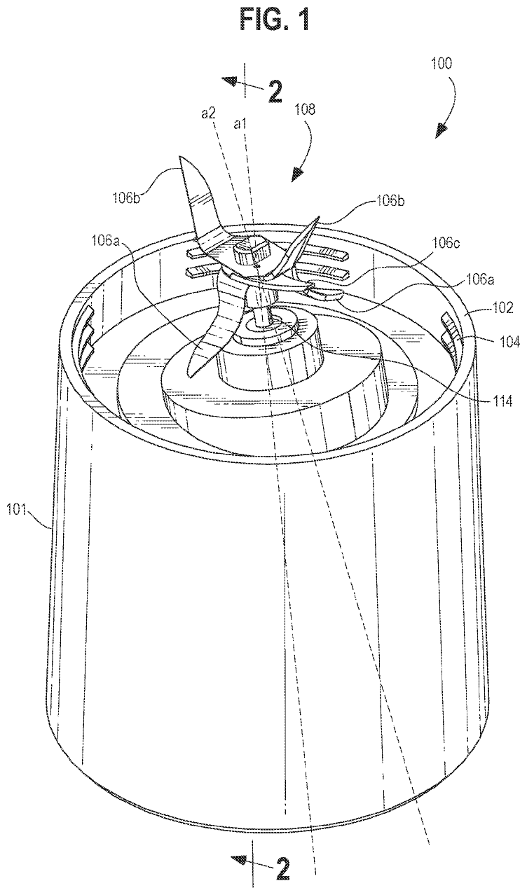

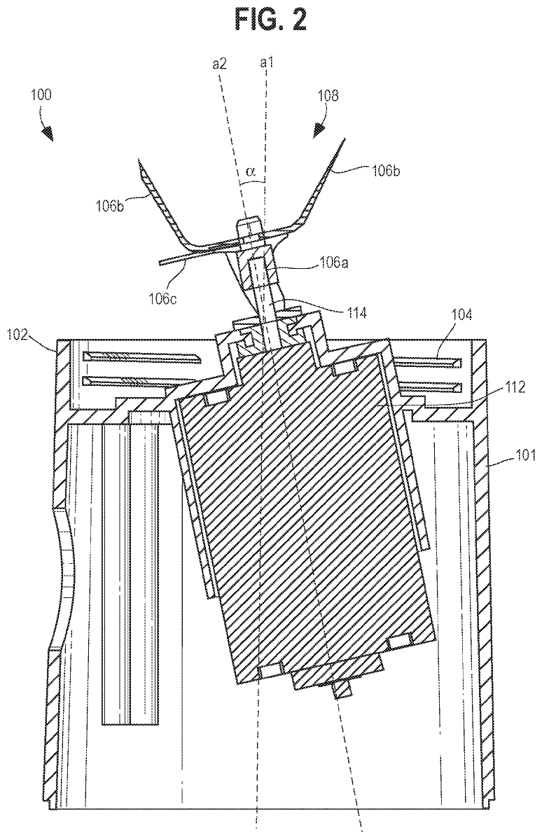

Referring to FIGS. 1 and 2, the present disclosure relates to a blender base, generally indicated by reference numeral 100. The blender base 100 can be used in conjunction with a blender container (not shown), together creating a blender assembly, to blend any desired ingredient and create various mixtures and foodstuffs, including blended beverages (such as juices, smoothies, shakes, and the like), sauces, soups, and other foodstuffs or mixtures typically created in blenders. Certain blender assemblies may also be utilized to chop ingredients inserted therein. As used herein, the term “foodstuffs” connotates any type of ingredient, whether it is solid, liquid, hot, cold, frozen, or any other appropriate state, or any combination thereof.

Typically, the blender base 100 and the blender container can be mechanically and releasably coupled during operation of the blender assembly, for example, through snap-fit, friction fit, threaded couplings, or any other means known in the art. In the illustrated embodiment, the blender base 100 comprises a main housing (body) 101 and a collar 102 extending around the upper perimeter of the housing 101, the collar 102 containing threads 104 on the interior portion thereof. The threads 104 can mate with corresponding threads on the blender container to releasably couple the blender vessel to the blender base 100.

In the illustrated embodiment, the base 100 has a longitudinal axis a1 and is generally cylindrical in shape, although other shapes are also suitable.

The blender base 100 can include one or more blades 106a, 106b, 106c (collectively referred to as the blade assembly 108). The blade assembly 108 can be rotatably coupled to the blender base 100 in order to blend foodstuffs. The blade assembly 108 can be mounted on or near the upper face of the blender base 100, and the blades 106a, 106b, 106c may or may not extend past the collar 102.

The illustrated embodiment includes two upward blades 106b, one horizontal blade 106c, and two downward blades 106a, although it will be foreseen that many combinations of blade positions can be utilized or desired depending upon application. As mentioned, the illustrated embodiment includes five blades 106a, 106b, 106c in its blade assembly 108. In general, the blade assembly 108 can include, for example, 1, 2, 3, 4, 5, 6, 7, 8, or more blades. The blades 106a, 106b, 106c may face any desired direction. For example, the blade assembly 108 can include at least one or at least two downward blades 106a to reduce and/or prevent foodstuffs underneath any upward blades 106b from remaining unprocessed or unblended.

A motor 112 can be preferably housed in the base housing 101 and can be operably coupled to and configured to rotationally drive the blade assembly 108. The motor 112 may be coupled to the blade assembly 108 via a motor shaft 114. The motor 112 can be powered by a battery, which, in some embodiments, can be a rechargeable battery. In some embodiments, and especially when the battery is a rechargeable battery, the battery is not removable by the user during common usage of the blender. It is intended that no power is derived from an external power source during use of the blender, although it is foreseen that, especially in the case of a rechargeable battery, the battery may be optionally coupled to an external power source during operation for battery recharge purposes. In other embodiments, the user can select whether the device runs on AC or DC power.

The motor shaft 114 has a longitudinal axis a2 about which the blade assembly 108 rotates. The longitudinal axis a2 of the motor shaft 114 can be generally angled with respect to the longitudinal axis a1 of the blender base 100. The angle α between the axes a1 and a2 may be greater than 0 degrees and less than 90 degrees, or less than 45 degrees. For example, the angle α is from about 5 degrees to about 25 degrees, from about 5 degrees to about 20 degrees, from about 5 degrees to about 15 degrees, from about 10 degrees to about 15 degrees, or from about 10 degrees to about 12 degrees. Thus, in some embodiments, the angle α can be from about 10 degrees to about 12 degrees. In contrast to non-angled motor shaft blenders which typically create a circular flow of blended products, the angled shaft may create an elliptical flow of product during normal usage of the blender. The angled motor shaft and elliptical flow created therefrom may allow for both upward and downward agitation and action of the foodstuffs inserted into the blender. The multi-action and multi-dimensional flow may improve the blender's efficiency to produce a more homogenously blended concoction with less energy and time expended.

In various embodiments, the motor 112 can be co-axial with the motor shaft 114. In other embodiments, the motor 112 is co-axial with the blender base 100. In the illustrated embodiment, the motor 112 is co-axial with the motor shaft 114 and generally centered within the housing 101. In other embodiments, the motor 112 may be off-centered within the housing 101 in order to aid in load balance during use of the blender with an angled blade assembly 108. In some circumstances, the angle of the motor shaft 114 and resulting elliptical flow of foodstuffs may create a load imbalance that can be counterbalanced by off centering the motor 112 within the housing 101.

In some embodiments, a controller (not shown) can be operably coupled to the motor 112 and can be configured to control the motor 112 during rotation of the blades 106. For example, the controller can control the speed of the rotation of the blade assembly 108. The controller may also be utilized to control the charging of the battery when a rechargeable battery is used. The controller can further be configured to control other functions or operations of the blender assembly.

In one embodiment, the controller can comprise a load sensing controller. The load sensing controller can be configured to sense load imbalance in the blender assembly (i.e., it is configured to sense a load imbalance in the blender base which is caused by a load imbalance in the blender container). A load imbalance in a blender container typically signals that a jam of ingredients underneath the blade assembly 108 has occurred. In order to dislodge the jammed ingredients, the load sensing controller may cause the motor 112 to increase or decrease the speed of rotation of the motor shaft 114, stop rotation of the motor shaft 114, and/or reverse rotation direction of the motor shaft 114. It will be understood that because the motor shaft 114 and blade assembly 108 are operably connected, any change in speed or direction of the motor shaft 114 rotation will cause a corresponding change in speed or direction of the blade assembly 108. The change in operation speed or direction is intended to cause any unprocessed ingredients stuck below or in the blade assembly 108 to dislodge. Allowing automatic removal of jams provides a more convenient, efficient, and safe mechanism for use than conventional manners relying on user intervention.

It will be understood that terms such as “upper,” “lower,” “above,” “below,” etc., are used to describe relative locations of various parts. These terms are intended to describe the relative position of components of the blender in the vertical position normally used for blender operation and should not be interpreted in a limiting sense.

Having described the invention in detail, it will be apparent that modifications and variations are possible without departing from the scope of the invention defined in the appending claims.

When introducing elements of the present invention or the preferred embodiment(s) thereof, the articles “a,” “an,” “the,” and “said” are intended to mean that there are one or more of the elements. The terms “comprising,” “including,” and “having” are intended to be inclusive and mean that there may be additional elements other than the listed elements.

As various changes could be made in the above products without departing from the scope of the invention, it is intended that all matter contained in the above description and shown in the accompanying drawings shall be interpreted as illustrative and not in a limiting sense.

1. A blender base comprising:
a housing;
a battery-powered motor housed within the housing;
a motor shaft operably and rotatably coupled to the motor; and
a blade assembly coupled to the motor shaft, the blade assembly comprising at least one blade;
wherein a longitudinal axis of the motor shaft is angled from about 5 to about 25 degrees with respect to a longitudinal axis of the housing.

2. The blender base of claim 1, further comprising a controller operably coupled to the motor, the controller configured to sense a load imbalance on the blender base, wherein when the controller senses a load imbalance on the blender base, the controller is configured to modify the speed and/or direction of the motor.

3. The blender base of claim 1, wherein the blade assembly comprises one or more upward blades, one or more horizontal blades, and one or more downward blades.

4. The blender base of claim 1, further comprising a battery housed within the housing and coupled to the motor.

5. The blender base of claim 4, wherein the battery is rechargeable.

6. The blender base of claim 1, wherein the longitudinal axis of the motor shaft is angled from about 10 to about 15 degrees with respect to a longitudinal axis of the housing.

7. The blender base of claim 1, wherein the motor shaft is angled with respect to the housing such that the blade assembly is configured to create an elliptical flow of foodstuffs during operation.

8. The blender base of claim 1, wherein a center point of the motor is not aligned with a center point of the housing.

9. The blender base of claim 1, wherein the motor is co-axial with the motor shaft and generally centered within the housing.

10. A blender assembly comprising:
a blender base comprising:
a housing;
a motor housed within the housing;
a motor shaft operably and rotatably coupled to the motor; and
a blade assembly coupled to the motor shaft, the blade assembly comprising at least one blade;
wherein a longitudinal axis of the motor shaft is angled more than about 0 degrees and less than about 90 degrees with respect to a longitudinal axis of the housing; and
a blender container releasably coupled to the blender base.

11. The blender assembly of claim 10, wherein the housing comprises a main body and a collar extending around an upper perimeter of the main body.

12. The blender assembly of claim 11, wherein collar comprises threads on an interior portion configured to mate with threads on the blender container to releasably couple the blender container to the blender base.

13. The blender assembly of claim 10, wherein the longitudinal axis of the motor shaft is angled from about 5 to about 25 degrees with respect to a longitudinal axis of the housing.

14. The blender assembly of claim 13, wherein the longitudinal axis of the motor shaft is angled from about 10 to about 15 degrees with respect to the longitudinal axis of the housing

15. The blender assembly of claim 10, wherein the motor is a battery-powered motor, and wherein the housing further houses a battery coupled to the motor.

16. The blender assembly of claim 11, wherein the blade assembly extends past the collar.

17. The blender assembly of claim 10, wherein the blade assembly comprises at least one downward blade.

18. The blender assembly of claim 17, wherein the blade assembly comprises at least two downward blades.

19. The blender assembly of claim 17, wherein the blade assembly comprises two upward blades, one horizontal blade, and two downward blades.

20. The blender assembly of claim 10, further comprising a controller operably coupled to the motor, the controller configured to sense a load imbalance on the blender base, wherein when the controller senses a load imbalance on the blender base, the controller is configured to modify the speed and/or direction of the motor.
